(19) United States
(12) Patent Application Publication
(10) Pub. No.: US 2010/0064010 A1
(43) Pub. Date: Mar. 11, 2010

(54) ENCOURAGING USER ATTENTION DURING PRESENTATION SESSIONS THROUGH INTERACTIVE PARTICIPATION ARTIFACTS

(75) Inventors: CHRISTOPHER SCOTT ALKOV, AUSTIN, TX (US); LISA SEACAT DELUCA, SAN FRANCISCO, CA (US); RUTHIE D. LYLE, DURHAM, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/205,398

(22) Filed: Sep. 5, 2008

(51) Int. Cl. G06F 15/16

(52) U.S. Cl. 709/206

(57) ABSTRACT

A presentation session can be identified in which at least one participant of the presentation session is associated with a computing device. A participation artifact can be conveyed to one or more participants. The participation artifact can be configured to solicit a response from a participant and to ensure that each artifact receiving participant is paying attention. The response can result from interactions between the associated participant and the computing device. The interactions can be specific to the participation artifact and can be responsive to a receipt of the participation artifact. A response to the participation artifact can be received from each participant receiving a participation artifact. The received response can be processed to assess an attention level of each participant receiving a participation artifact.

### BACKGROUND

The present invention relates to the field of collaboration and, more particularly, to tracking and encouraging user attention during presentation sessions through interactive participation artifacts.

A common problem that has plagued presenters of meetings and conferences is keeping the audience engaged and focused on the presentation. This is an especially prominent problem for presentations when one or more participants of the presentation virtually engages in a presentation session via a virtual attendance technology (i.e., attend via a teleconference technology, a video conference technology, an on-line chatting technology, an instant messaging technology, remote desktop sharing technology, etc.). The problem is also exasperated in settings where participant-to-lecture interactions are minimal (e.g., large conference/lecture rooms or stadiums). In such situations, it is easy for a user to engage in an ancillary activity unrelated to the presentation session, while the presentation session is occurring, such as reading email, surfing the Web, reading a newspaper, etc.

To address this problem, presenters of geographically centralized (e.g., physical meetings as opposed to virtual meetings, teleconferences, and the like.) have frequently used entertaining anecdotes to keep participant's attention. While this has been useful in the past, it can often be distracting for the presenter and audience. It is not uncommon for audience members to focus on the anecdote and miss critical points being conveyed by the presenter. Further, presenters often try to solicit responses from audience members through questions. This is not always possible as many times presentations do not lend themselves to an interactive dialog. Frequently, it is not possible or practical for presenters to directly engage these participants and/or gain participation feedback from them.

### BRIEF DESCRIPTION OF THE SEVERAL VIEWS OF THE DRAWINGS

FIG. 1 is a schematic diagram illustrating a set of scenarios for evaluating and encouraging participant attention during presentation sessions in accordance with an embodiment of the inventive arrangements disclosed herein.

FIG. 2 is a schematic diagram illustrating a system for monitoring participant attention during presentation sessions in accordance with an embodiment of the inventive arrangements disclosed herein.

FIG. 3 is a flowchart illustrating a method for assessing participant attention during presentation sessions in accordance with an embodiment of the inventive arrangements disclosed herein.

### DETAILED DESCRIPTION

The present invention discloses a solution for tracking and encouraging user attention during presentation sessions through interactive participation artifacts. In one embodiment, one or more participant can be virtually attending the presentation session via a virtual attendance technology (e.g., a teleconference technology, a video conference technology, an on-line chatting technology, an instant messaging technology, a remote desktop sharing technology, etc.). Presentation session interactions can occur in real-time. In the solution, a presentation system configured to assess user participation in a presentation session can be used by presenters to track and determine user attention. The presentation system can convey participation artifacts to users which require user interaction. Based on the user response or lack of response, the system can determine user attention. Participation artifacts can include trivial tasks, simple games, questionnaires, directed questions, and the like. The participation assessment can be manually invoked by the presenter or automatically performed based on configuration settings. Results of the participation assessment can be conveyed to the presenter and/or a moderator which can be used to assist the presenter.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

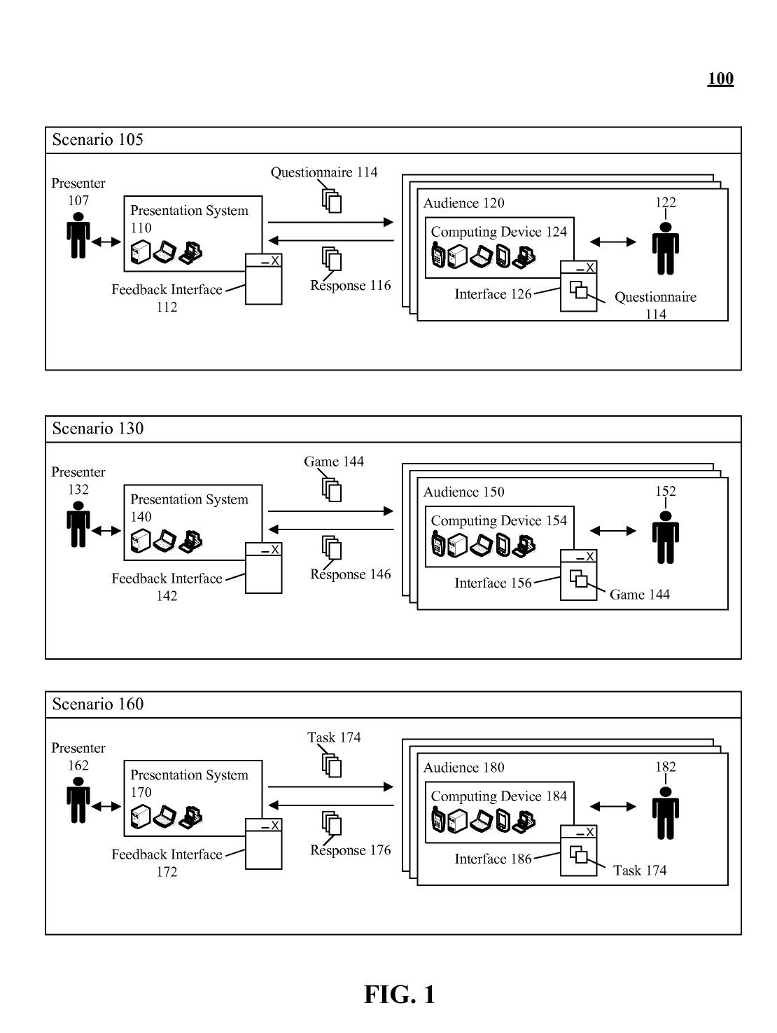

FIG. 1 is a schematic diagram illustrating a set of scenarios 105-160 for evaluating and encouraging participant attention during presentation sessions in accordance with an embodiment of the inventive arrangements disclosed herein. In one embodiment, one or more of the participants can be located in a different geographic location form the presenter, where a virtual attendance technology is utilized. Presentation session interactions can occur in real-time. In the scenarios 105, 130, 160, presentation system 110, 140, 170 can enable presenter 107, 132, 162 to determine audience 120, 150, 180 attentiveness. Participation artifacts 114, 144, and 174 can aid in assessing participant 122, 152, 182 attention, in encouraging participant to listen to content of the presentation session, and in assisting the presenter 107, 132, 162 to present content in an engaging fashion.

As used herein, a presentation session can include lectures, promotional events, meetings, conference calls, video conferences, Web-based seminars, podcasts, and the like. Participation artifacts 114, 144, 174 can include trivial tasks, simple games, focused inquiries, questionnaires, user interactive events, and the like. For instance, a participation artifact 114, 144, 174 can range from a notification designed to gain the attention of a participant 122, 152, 182 (e.g., a ping) to a group based game enabling multiple participants 122, 152, 182 to compete and/or cooperate to achieve a goal. Transmission of participation artifacts 114, 144, 174 to participants can be a result of a manual invocation by a presenter 107, 132, 162. Alternatively, the presentation system 110, 140, 170 can automatically convey participation artifacts 114, 144, 174 at random intervals during the presentation sessions based on a set of system 110, 140, 170 or presenter 107, 132, 162 defined rules.

The scenarios 105, 130, 160 can illustrate a video conference meeting where a presenter 107-162 can utilize a presentation system 110, 140 170 to communicate with one or more local and/or remote meeting participants 122, 152 182. Participants 122, 152 182 can use computing devices 124, 154, 184 which can aid them in interacting with the presenter 107, 132, 162, participants 122, 152 182, and/or conveyed participation artifacts 114, 144, 174. In one embodiment, participation artifacts 114, 144, 174 can be conveyed to all participants 122, 152 182 in the meeting, a selected subgroup, or individual participants 122, 152 182.

Further, participation artifacts 114, 144, 174 can be conveyed repeatedly to participants 122, 152 182 during a presentation session as deemed necessary by a presenter 107, 132, 162. When a participant 122, 152 182 fails to respond to a participation artifact 114, 144, 174, the system 110, 140, 170 can note the participant 122, 152 182 as inattentive, which can result in a triggering of a predefined programmatic action. In various implementation situations, the programmatic action can be a reward/punishment given to participants 122, 152, 182, can be a queue to a presenter 107, 132, 162, can be an evaluation metric of the presenter's performance or a meeting topic's success, and the like.

For example, in a classroom setting, additional homework can be automatically assigned by system 110, 140, 170 for “inattentiveness.” In a business lecture setting, “prizes” can be selectively presented to attentive participants 122, 152, 182. In one embodiment, a presenter 107, 132, 162 can be presented with indictors during a presentation concerning participant 122, 152, 182 attentiveness, which can permit the presenter 107, 132, 162 to dynamically adjust the presentation to maintain participant 122, 152, 182 interest. In another embodiment, the presenter's performance can be automatically accessed or scored based upon an attention level of the participants 122, 152, 182 as determined from responses 116, 146, 176 using system 110, 140, 170. In another example, an often repeated lecture or other presentation can be “optimized” by recording attention level of participants 122, 152, 182 against presentation content based upon the responses 116, 146, 176 showing participant interest level relative to presentation topics, where topics associated with low attentiveness can be shortened or otherwise adjusted as appropriate during subsequent iterations of the repeated presentation.

Unlike traditional “attention grabbing” techniques during presentations, which cause a presenter 107, 132, 162 to deviate from a central topic (e.g., present an anecdote, joke, etc.), use of participation artifacts 114, 144, 174 can occur outside the main “stream” of a presentation. Further, a presenter 107, 132, 162 is not necessarily forced to distract themselves from the main stream of a presentation to create attention seizing dialog. In fact, the artifacts 114, 144, 174 can be automatically generated/chosen by the system 110, 140, 170 in one implementation of the system 100. Even when the presenter 107, 132, 162 triggers a participation artifact 114, 144, 176 to be conveyed to one or more participant 122, 152, 182, the presenter 107, 132, 162 need not specify a type of artifact 114, 144, 174 that is conveyed or specific semantic content of that artifact 114, 144, 174 (although some embodiments of the invention can empower a presenter 107, 132, 162 with this level of granularity of control). Thus, a presenter 107, 132, 162 can largely focus their attention on the main stream of presentation content without diverting their attention overly much during a presentation.

In one embodiment, an aid to the presenter 107, 132, 162 can exist, who coordinates/controls specifics of the participation artifacts 114, 144, 174 during a lecture. For example, in a classroom context, a teaching assistant (TA) can convey artifacts 114, 44, 174 to participants 122, 152, 182 who appear to be distracted during a lecture. In another example, a meeting facilitator can direct a presentation flow using artifacts 114, 144, 174 and prompts to a presenter 107, 132, 162 (based upon responses 116, 146, 176) to enhance an overall presentation experience. In one embodiment, the presentation system 110, 140, 170 can be configured in an entirely automated fashion, where artifacts 114, 144, 174 are conveyed responsive to a set of configurable and programmatically implemented rules.

In general, system 100 is a highly flexible solution, which can be applied to enhance presentations, meetings in many contexts. Specifics of the solution can also be tailored to circumstances of a particular situation. For example, artifacts 114, 144, 174 appropriate for a virtual meeting situation can be very different in character and nature from ones 114, 144, 174 suitable for a large lecture hall. The flexible nature of system 100 has been expressed in FIG. 1, by showing a set of different implementation scenarios 105, 130, 160. System 100 is not to be construed as limited to any of these scenarios 105, 130, 160, or to implementation specifics expressed within these scenarios 105, 130, 160, which are presented for illustrative purposes only.

In scenario 105, a presenter 107 can evaluate an audience 120 attention at a given time during the presentation session using participation artifact 114. The presenter 107 interacting with feedback interface 112 can trigger questionnaire 114 to be delivered to the computing device 124. Participant 122 can be presented with questionnaire 114 via interface 126. Questionnaire 114 can include a question or set of questions relevant to the presentation session. In one embodiment, questionnaire 114 can be a short survey relevant to a presentation given by presenter 107. If participant 122 responds to the conveyed questionnaire 114, the response 116 can be transmitted in real-time to presenter 107. Response 112 can be presented to the presenter via feedback interface 112. In one instance, questionnaire 114 participation artifact can be used by presenter 107 to determine if participant 122 understands presented material.

In scenario 130, a presenter 132 can utilize a game 144 participation artifact to assist in keeping the attention of audience 150. A presenter 132 finding that their audience is distracted (e.g. from a previous participation assessment) can use game 144 to engage participants. For instance, presenter 132 can address the problem of a bored participant 152 by allowing system 140 to convey game 144 to participant 152. Game 144 can be a trivial user interactive game relevant to the presentation session. Alternatively, game 144 can be a non-relevant game useful in drawing the attention of participant 152 (e.g. a mini-break). In one embodiment, game 144 can be an interactive game allowing presenter 132 and participant 152 to play against each other via interfaces 142 and 156. In another embodiment, game 144 can enable participants to play against a computer player or other participants. Game outcomes can be conveyed to presenter 132 as response 146 and presented via feedback interface 142.

In scenario 160, a presenter 162 can assign trivial tasks 174 to audience 180 which can aid in keeping the audience attention. Presenter 162 can utilize participation artifact 174 to maintain audience 180 focus during complicated presentations which can cause participants to be distracted or inattentive. For instance, presenter 162 can permit presentation system 170 to convey task 174 to participant 182 to help participant 182 stay focused on the presentation. Task 174 can include one or more meeting relevant tasks such as arranging an ordered list or a word/concept matching task. In one embodiment, the task 147 can be a duty associated with the meeting that is to be performed at a later time. Task 174 can be presented via interface 186 of computing device 184. Upon completion of trivial tasks, the results can be conveyed as response 176 to presenter via feedback interface 172.

Computing device 124, 154, 184 can include hardware/software/firmware capable of facilitating communication during a meeting and able to present one or more participation artifacts. Computing device 124, 154, 184 can facilitate communication with one or more presenters and/or participants. Participation artifacts 114, 144, 174 can be presented visually, aurally, or both via an interface associated with the computing device 124, 154, 184. System 140 can include hardware/software/firmware capable of managing/serving/processing artifacts 114, 144, 174 and responses 116, 146, 176. System 140 can be implemented within a stand-alone physical machine and/or using a plurality of distributed physical machines that are communicatively linked to each other.

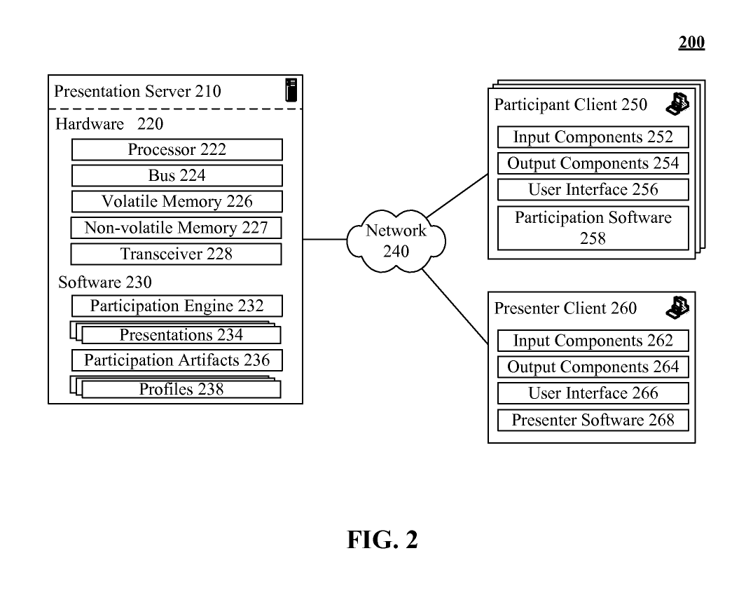

FIG. 2 is a schematic diagram illustrating a system 200 for monitoring participant attention during presentation sessions in accordance with an embodiment of the inventive arrangements disclosed herein. The scenarios 105, 130, 160 of FIG. 1 can utilize system 200 components.

In system 200, a presentation server 210 can be communicatively linked to one or more participant clients 250 and presenter client 260 via a network 240. The presentation server 210 can manage, provide, and/or process participation artifacts. Each participant client 250 can receive participation artifacts and can permit users to interact with these artifacts. The presenter client 260 can be used by a presenter to trigger events for sending participation artifacts to participant clients 250 and/or for presenting results of processing responses to participation artifacts. The participant clients 250 can be located in geographic proximity to the presenter client 260 and/or can be located remotely from the presenter client 260 so long as each is connected to network 240. In one embodiment, the presenter client 260 can be located (and controlled) remotely from a geographic location of a presenter, such as when a facilitator or agent who is not the presenter is controlling participation artifacts during a presentation.

Presentation server 210 can include a set of hardware 220 and software/firmware 230. The hardware 220 can include one or more processors 222 connected to a volatile memory 226, a non-volatile memory 227, and/or a transceiver 228 via a bus 224. Each processor 222 can programmatically process a set of programmatically implemented instructions. The volatile memory 226 can be a storage medium configured to store programmatic instructions for a computing session. The non-volatile memory 227 can be a storage medium configured to store the software/firmware 230 and can store persistent data/executable objects. Transceiver 228 can be a network transceiver connecting server 210 to network 240. The hardware 220 can be located within one or more computing devices/machines that are functionally interconnected. For example, presentation server 210 can be a stand-alone server, a set of distributed servers, a virtual server, a cluster of servers, and the like in various contemplated implementations of system 200.

Software/firmware 230 of server 210 can include participation engine 232, a set of presentations 234 files, participation artifacts 236, participation history data, participant profile data 238, and the like.

The participation engine 212 can manage, process, and otherwise handle participation artifacts 236. The participation engine 232 can respond to triggers from the presenter client 260, which causes one or more participation artifacts 236 to be presented to a set of one or more participant clients 250. The participation engine 232 can also include a set of rules, which determine when, if ever, participation artifacts 236 are to be automatically conveyed to participant clients 250. Other programmatic rules can determine programmatic actions that are to be taken responsive to receiving responses to the conveyed participation artifacts 236. These programmatic rules can be configured for a specific presentation, presenter, participant, and the like.

In one embodiment, the participation engine 232 can be synchronized with one or more participation artifacts 234. For example, a presentation 234 file/object, such as a slideshow or an agenda, can include content items and milestones. These milestones can be associated with participation artifacts in numerous manners. For example, a frequency with which participation artifacts can increase during a “boring” portion of a presentation or decrease during a period immediately preceding or following a break. In one embodiment, the presentation 234 file/object itself can include triggers specific to participation artifacts (i.e., a slideshow presentation can specify that participation artifacts of a designated type are to be conveyed to 30% of the participants when the slide of the slideshow is shown). In another embodiment, the presentation engine 232 can select only those artifacts 236 appropriate for a specific presentation stage. For example, a trivia/task artifact for a given presentation topic can be “activate” or capable of being presented only after a presentation segment for that presentation topic has been conducted.

In one embodiment, a learning algorithm can be implemented within the participation engine 232. That is, engine 232 can be configured to associate presentation 234 objects with participation artifacts 236 and participation history. This association can allow system 200 to be highly configurable, easily maintained, and to increase in effectiveness over time. Engine 232 can determine participant attentiveness based on results garnered from participation interaction with conveyed participation artifacts 236. Engine 232 can assess participant attentiveness based on a set of threshold values such as the length of time participants take to interact with conveyed artifacts, the accuracy in which artifacts were interacted with, and the like. Alternatively, engine 232 can operate using a dual value behavior system such as participant being flagged as active or inactive. Behavior of engine 232 can be tailored to specific participants, who can have participant specific profiles 238, to specific presenters (who can also have profiles, not shown), and to other situational factors. For example, a participant “known” based upon historic data to be inattentive can be prompted with participation artifacts more often than another participant having a profile 238 indicating attentiveness.

Presentation 234 files/objects can be any object utilized during a course of a presentation. For example, a presentation 234 file/object can include an agenda, a slideshow, a multimedia object presented during a presentation, a handout, meeting minutes, a meeting synopsis/summary, a presentation survey, a presenter evaluation document, and the like. In one embodiment, one or more of the presentation 234 objects can be available to participants of a meeting before/after the meeting is conducted. Presentation 234 objects can include presenter supplied objects, objects supplied by a presentation supervisory entity, and/or by participants themselves.

A presentation can be defined as any collaboration event involving more than one individual. A presentation can include a meeting, a lecture, a discussion, a brain storming session, a chat forum, and the like. The presentation can be directed, which includes one or more official presenters or moderators being designated for predetermined segments of a presentation. A presentation can also be non-directed, where participants can dynamically assume a role of a “presenter” or a “listener” during a course of a presentation.

In one embodiment, a presentation can be a real-time or a near real time presentation. In another embodiment, a presentation can include one “pre-taped” component as well as a real-time component. For example, many lectures or lecture segments are recorded and later broadcasted to a set of subsequent participants, who are able to interact with each other and/or a presentation facilitator in real time during the re-playing of the recorded segment. In still another embodiment, the presentation can be a pre-recorded one where a single user interacts (plays the presentation at a time of their choosing), and thus involves no real-time interaction with other humans. For example, many lectures/presentations (i.e., those for continue education credit for professionals, those to designed to reduce points for traffic infractions, etc.) exist, which would significantly benefit through an addition of participation artifacts 236 that monitor/enforce an established participation level.

Participation artifacts 236 can include trivial tasks, simple games, focused inquiries, questionnaires, user interactive events, and the like. Artifacts 236 can be human created/tailored artifacts and/or a set of default system provided artifacts. Artifacts 236 can be shared amongst users enabling reuse and facilitating minimal overhead when implementation is performed.

Profiles 238 can enable server 210 can establish participant/presenter specific data, which can affect behavior of engine 232 in a person specific manner. In one embodiment, a participant/presenter can be permitted to access (e.g., view, edit, or otherwise configure) portions of their profile 238. For example, profiles 238 can allow presenters to select how and when participation artifacts 236 are conveyed to participants during meetings and can configure a type of programmatic response that is to be selectively preformed depending upon a participant response to a conveyed participation artifact 236. In another example, profiles 238 can be used by a participant establish preference as to a type of participation artifact 236 that a participant prefers to receive. For example, one participant may prefer to receive trivia related to a presentation, may prefer to receive a question regarding to already presented content, or may prefer to engaged in an interactive game with other participants, when possible.

Each of the clients 250, 260 can include input components 252, 262, output components 254, 264, and/or user interfaces 256, 266 as well as software 258, 268 for interacting with server 210. Configuration specifics of the clients 250, 260 can vary dramatically based upon implementation specifics. For example, in one embodiment, client 250 can be a personal computer used by a participant virtually attending a presentation session. As such, input components 252 can include a keyboard, mouse, microphone, etc.; output components 254 can include a display, speaker, etc.; user interface 256 can include a graphical user interface (GUI), a voice user interface (VUI), etc.; and, the participation software 258 can include e-meeting software, participation artifact interaction software, etc.

In another embodiment, the clients 250 can include a set of interactive controls/devices configured for a lecture hall, such as interactive devices/buttons/thin clients/fat clients that receive participant input. As such, input components 252 can include a set of buttons, dials, controls, a remote control, an interactive tablet, etc; output components 254 can include a text display, a speaker, a set of LED indicators, etc.; the user interface 256 can include mechanical/electronic/computer components; and the participation software 258 can reside locally, in a server, or can be contained within firmware/electronics of interactive components.

In one embodiment, input devices, which include input components 252 and externally implemented sensors, can exist in system 200 to assist in accessing a level of attention of one or more participants. For example, microphones can detect an ambient noise level of a lecture hall or a participant work station. The ambient noise level when high can indicate a lack of attentiveness or when below a certain threshold can even indicate a lack of physical presence of a participant. In one embodiment, automated audio processing technologies can be used to distinguish from on-topic or expected speech and off-topic speech based upon semantic content of the captured and processed audio. In another example, a video capture device can be used to capture video, which can be processed to programmatically determine a level of participant attention using behavioral cues included within the captured video. In yet another example, biometrics (galvanic skin response, heart rate, pupil dilation, etc.) can be captured by sensors and used when determining an attentiveness level of the participants.

Network 240 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 240 can include local components and data pathways necessary for communications to be exchanged among computing device components and between integrated device components and peripheral devices. The network 240 can also include network equipment, such as routers, data lines, hubs, and intermediary servers which together form a packet-based network, such as the Internet or an intranet. The network 240 can further include circuit-based communication components and mobile communication components, such as telephony switches, modems, cellular communication towers, and the like. The network 240 can include line based and/or wireless communication pathways.

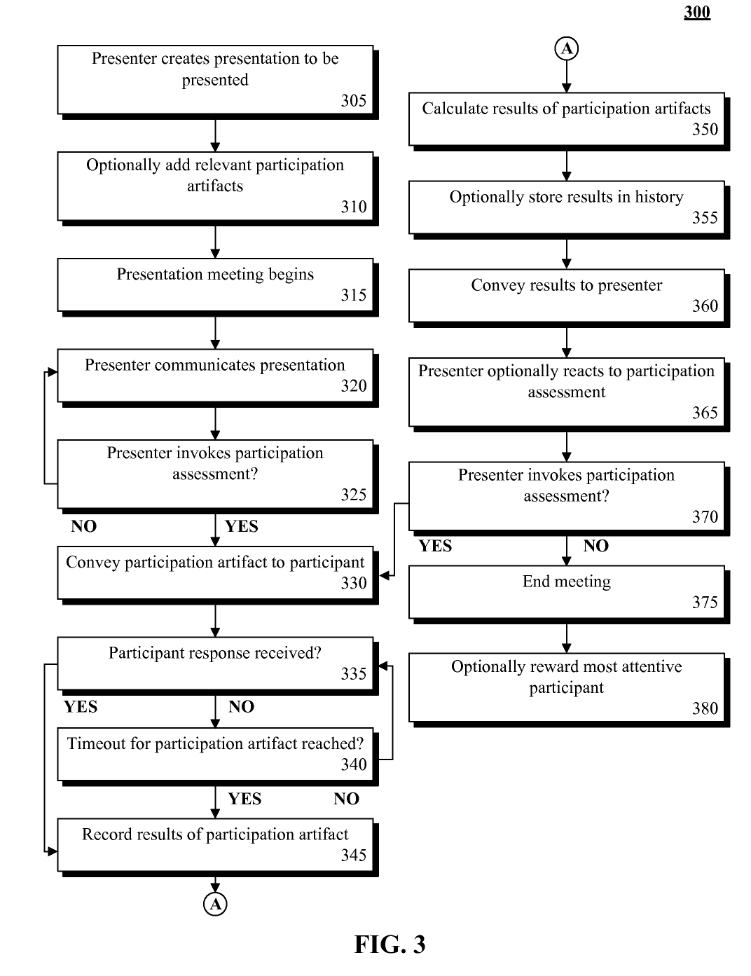

FIG. 3 is a flowchart illustrating a method 300 for assessing participant attention during presentation sessions in accordance with an embodiment of the inventive arrangements disclosed herein. Method 300 can be performed in the context of system 200.

In step 305, the presenter creates a presentation to be communicated to an audience (e.g. participants). This step can include registering a meeting event with a presentation system and/or creating a presentation event with the desired presentation entities. In step 310, the presenter can optionally add relevant participation artifacts to be used during the presentation for assessing participant attention. The presenter can choose from a library of participation artifacts, create customized participation artifacts, and the like. In step 315, the presentation event begins. In step 320, the presenter communicates the presentation content to the participants. In step 325, if the presenter invokes a participation assessment action, the method can continue to step 330, else return to step 320. The invocation of the participation assessment need not be driven by the presenter but can be automatically evened by an automated system in response to a programmatically defined triggering condition.

In step 330, the presentation system can convey participation artifacts to participants. The presenter (or automated system) can choose to convey artifacts to all participants or to only a selected subgroup. In step 335, if a participant response is received the method can proceed to step 345, else continue to step 340. In step 340, if the timeout for the participation artifact is reached, the method can continue to step 345, else return to step 335. In step 345, the presentation system records the results of the conveyed participation artifact.

In step 350, the system can calculate results of the participation artifacts. These results can trigger any number of responsive programmatic actions. For example, in one embodiment, the results can be assembled into a user friendly report. In step 355, the system can optionally store results in a participant history which can be used for enabling the system to act intelligently when automated functionality is chosen. For instance, participation assessments can be transmitted to only participants who have frequently been recorded as inactive. In step 360, the results can be optionally conveyed to the presenter. In step 365, the presenter can react to the results of the participation assessment. For instance, if the results note many participants are inattentive, the presenter may choose to modify their presentation style.

In step 370, if the presenter invokes a participation assessment the method can return to step 330, else continue to step 375. In step 375, the presentation session can end and a comprehensive report can be presented detailing all participation assessment results. In step 380, the system can optionally reward/penalize the most/least attentive participant(s). For instance, the system can notify the presenter, who can take actions to reward the participant. In one embodiment, reward(s)/punishment(s) for attention level can be implemented during a presentation, which provides a mechanism designed to encourage participants to modify their behavior during a presentation.

The flowchart and block diagrams in the FIGS. 1-3 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for enhancing participant attention during a presentation comprising:
identifying a presentation session in which at least one participant of the presentation session is associated with a computing device;
conveying a participation artifact during the presentation session to the at least one participant, wherein the participation artifact is configured to solicit a response from the at least one participant and to ensure that the artifact receiving participant is paying attention, said response resulting from interactions between the at least one participant and the computing device, wherein said interactions are specific to the participation artifact and responsive to a receipt of the participation artifact;
receiving a response to the participation artifact from each participant receiving the participation artifact; and
processing the received response to assess an attention level of each participant receiving the participation artifact.

2. The method of claim 1, wherein the presentation session is a real-time communication session comprising a presenter and the at least one participant, wherein the at least one participant comprises a plurality of participants.

3. The method of claim 2, wherein at least one of said participants is geographically remote from said presenter, and wherein a virtual attendance technology is utilized to enable the at least one geographically remote participant to virtually attend the presentation session.

4. The method of claim 3, wherein the virtual attendance technology comprises at least one of a teleconference technology, a video conference technology, an on-line chatting technology, an instant messaging technology, and a remote desktop sharing technology.

5. The method of claim 1, wherein the participation artifact comprises a game to be played by the at least one participant.

6. The method of claim 1, wherein the participation artifact comprises a questionnaire to be completed by the at least one participant.

7. The method of claim 1, wherein the participation artifact comprises a task to be performed by the at least one participant.

8. The method of claim 1, further comprising:
presenting an indication of audience attention level based at least in part upon the processed assessment of the participant's attention level, wherein the indication is presented to a presenter during the presentation session.

9. The method of claim 1, further comprising:
rewarding a participant when the processed assessment of the participant's attention level is above a previously designated threshold.

10. The method of claim 1, further comprising:
punishing a participant when the processed assessment of the participant's attention level is below a previously designated threshold.

11. The method of claim 1, further comprising:
recording metrics for the presentation session based at least in part upon the processed assessment of the participant's attention level, wherein the recorded metrics is feedback of a participant satisfaction with at least one of a presenter and the presentation session.

12. The method of claim 1, further comprising:
automatically conveying the participation artifact based upon a randomizing factor.

13. The method of claim 1, further comprising:
detecting a selection by a presenter of the presentation session to convey at least one participation artifact, conveying the participation artifact in response to the detected selection.

14. The method of claim 1, further comprising:
conveying at least one presentation object to the at least one participant during the presentation session, wherein the presentation object comprises semantic content applicable to a corresponding time segment of presentation session.

15. The method of claim 14, further comprising detecting a programmatic trigger specified within the presentation object, wherein the programmatic trigger causes in the participation artifact to be conveyed to the at least one participant.

16. The method of claim 14, further comprising:
time synchronizing the presentation object with semantic content of the participation artifact.

17. The method of claim 1, wherein the participation artifact comprises semantic content of the presentation session presented during the presentation session before the participation artifact is conveyed to the at least one participant.

18. A computer program product for enhancing participant attention during a presentation comprising:
a computer usable medium having computer usable program code embodied therewith, the computer usable program code comprising:
computer usable program code configured to identify a presentation session in which at least one participant of the presentation session is associated with a computing device;
computer usable program code configured convey a participation artifact during the presentation session to the at least one participant, wherein the participation artifact is configured to solicit a response from the at least one participant and to ensure that the artifact receiving participant is paying attention, said response resulting from interactions between the at least one participant and the computing device, wherein said interactions are specific to the participation artifact and responsive to a receipt of the participation artifact;
computer usable program code configured receive a response to the participation artifact from each participant receiving the participation artifact; and
computer usable program code configured process the received response to assess an attention level of each participant receiving the participation artifact.

19. A computing device for enhancing participant attention during a presentation comprising:
a processor;
a non-volatile memory;
a volatile memory; and
a bus communicatively linking the processor, non-volatile memory, and the volatile memory, wherein said non-volatile memory comprises software executable by the processor utilizing the volatile memory, wherein said software is configured to:
identify a presentation session in which at least one participant of the presentation session is associated with a computing device;
convey a participation artifact during the presentation session to the at least one participant, wherein the participation artifact is configured to solicit a response from the at least one participant and to ensure that the artifact receiving participant is paying attention, said response resulting from interactions between the at least one participant and the computing device, wherein said interactions are specific to the participation artifact and responsive to a receipt of the participation artifact;
receive a response to the participation artifact from each participant receiving the participation artifact; and
process the received response to assess an attention level of each participant receiving the participation artifact.
